(19) United States
(12) Patent Application Publication
(10) Pub. No.: US 2005/0073999 A1
(43) Pub. Date: Apr. 7, 2005

(54) Delivery of profile-based third party content associated with an incoming communication

(75) Inventor: Robert A. Koch, Norcross, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(73) Assignee: BellSouth Intellectual Property Corporation

(21) Appl. No.: 10/994,596

(22) Filed: Nov. 22, 2004

Related U.S. Application Data
(63) Continuation-in-part of application No. 10/144,555, filed on May 13, 2002.

(51) Int. Cl. H04L 12/66

(52) U.S. Cl. 370/352

(57) ABSTRACT

The present disclosure provides a system and method for supplying third party information to a receiving party having a device coupled to the Internet. One embodiment of the present disclosure includes a method and apparatus for providing content to the recipient of an incoming phone call as a data message displayed to the receiving party. In return, the receiving party and/or calling party receive consideration from a content provider. Another embodiment of the present disclosure provides methods and apparatus for the recipient of the content to dictate the nature of the content that they will receive in their content messages by establishing a profile of information that indicates to the content provider the type of information that they prefer to receive.

### CROSS-REFERENCE TO RELATED APPLICATIONS

This application is a continuation-in-part of U.S. application Ser. No. 10/144,555, entitled “Third Party Announcements for Internet Caller ID Messages,” filed May 13, 2002, and incorporated herein by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### TECHNICAL FIELD

The present disclosure is generally related to communications, and more particularly, to the delivery of information supplied by a third party to the recipient of an incoming communication attempt according to pre-defined profile preferences as defined by the recipient.

### BACKGROUND

Caller-ID is a telephone service that provides, for subscribers of the service, identification information about a telephone caller. This information typically appears on a display of a telephone or on a separate small display device of the subscriber, as the call is being received. In signal system 7 (SS7) systems, caller-ID information is transmitted on the subscriber loop using frequency shift keyed (FSK) modem tones. The FSK modem tones are used to transmit the display message in American Standard Code for Information Interchange (ASCII) character code form, where the transmission on the display message takes place between the first and second ring. Standard caller-ID information includes the date, time, and calling number, and sometimes, the name associated with the calling number. However, today's caller-ID devices are limited by the amount of information about the calling party that can be transmitted and displayed to the called party over conventional telephone systems.

Although telephones have traditionally been “always on,” meaning that they are generally continuously able to receive a call over the telephone network, data communications involving the Internet often were not. Customarily, a person connected to the Internet once used a dial-up service and a computer linked to a phone line via a modem. In establishing dial-up service, the user made a call to an Internet service provider (ISP), where the eventual Internet connection was only active during the duration of a telephone call. However, recent technologies, such as digital subscriber line (DSL) communication, cable modem communication, and satellite communication enable computers and other Internet devices to be “always-on” for data communications at the same time that telephones are “always-on” for voice communications. Standard DSL service works by connecting a DSL modem on each end of a twisted pair telephone line. The DSL modems create separate voice and data channels, by sending data communications over a different part of the frequency spectrum than analog voice signals. Thus, DSL allows for voice and data communications to occur simultaneously over the same phone line. Consequently, a user may converse over a telephone to his friend, while the user is also emailing a message over the Internet to a family member.

The counterpart to DSL is cable modem technology and Internet satellite communications. Both cable modems and satellites are further ways to engender simultaneous data and voice communications over separate communication mediums. In cable modem technology, data communications are sent over a local cable TV line at the same time that a telephone can send voice communications over a phone line. Correspondingly, for Internet satellite communications, data signals are transmitted to and from the Internet using satellites, leaving phone lines free for voice communications.

With the influx of “always-on” technology, especially with data communication concerns, technologies have been developed that seek out users. Unlike standard email and web applications, which pull information from the Internet that is requested by a user, recent applications push information to a user. “Pushing” describes a technology in which specific data is sent to a recipient without it being specifically requested by the recipient at the moment. Additionally, instant messaging is another technology, where information is sent to a user without necessarily being stored on a server, in some implementations. In instant messaging, the messages created by a sender are delivered to a recipient in almost “instant” time. Even during peak Internet usage periods, the delay is rarely more than a second or two.

At or around the time of the present application, “always-on” usage accounts for over fifty percent of the total online Internet population. Therefore, it is becoming commonplace to be connected to the Internet at the same time that a telephone is also connected to a telephone network.

Moreover, wireless telephones and other wireless devices capable of both voice and data communication are becoming much more prevalent. While these devices are typically not “always-on”, when they are on, they offer the capability of being able to receive both incoming voice call attempts and incoming data communications. These data communications can be in the form of text messages (email, Short Message Service (SMS) messages, instant messages), or richer content such as web pages formatted for display on the smaller screen of a handheld wireless device.

Unfortunately, the conventional caller-ID service has not expanded in functionality as Internet connection times have increased. Opportunities exist to deliver additional content to a receiving party of a call associated with an incoming call attempt. Therefore, there is a need for improved systems and methods that address the aforementioned deficiencies and inadequacies.

### SUMMARY

Exemplary embodiments of the present disclosure provide systems and methods for supplying third party information to a receiving party having a device coupled to the Internet. One embodiment of the present disclosure includes a method and system for providing Internet caller-ID service, wherein content is placed in Internet caller-ID messages. In return, the receiving party and/or calling party receive consideration from a content provider.

Another embodiment of the present disclosure provides methods and apparatus for the recipient of the content to dictate the nature of the content that they will receive in their content messages by establishing a profile of information that indicates to the content provider the type of information that they prefer to receive. For example, there may be specific retail stores or other businesses with which the receiving party normally does business. The receiving party would prefer to receive advertising from their preferred businesses as opposed to a random list of businesses, making the utility of the information that is delivered to the receiving party greater. Likewise, there may be preferred types of timely information that the receiving party would like to receive, e.g., entertainment news, local news, stock information for specific stocks, and weather information for their hometown.

By providing methods and apparatus to deliver pre-specified preferred information to a receiving party along with an incoming call attempt, the present disclosure provides a solution to the need for a technology that delivers information to a receiving party on a periodic basis (as frequently as incoming phone calls arrive) when the party is being alerted of another incoming communication. Thus the receiving party's preferred information is delivered to them “piggy-backed” on an incoming phone call. Moreover, it is provided in such a way as to offer the opportunity for the content provider to provide consideration to the receiving party (in the form of discounts, coupons, payments that subsidize the cost of the communication service to the receiving party, or other compensation.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a block diagram of one embodiment of a communication system of the present disclosure.

FIG. 1B is a more detailed diagram of the communication system of FIG. 1A.

FIG. 2 is a flowchart of one embodiment of a method for sending and receiving caller-ID messages over the Internet.

FIG. 3 is a flowchart describing an embodiment of the setup process in FIG. 2.

FIG. 4 is a flowchart describing an embodiment of the process for designating a resource locator in FIG. 2.

FIG. 5 is a flowchart describing an embodiment of the process of supplying third party content to Internet caller-ID messages according to the disclosure.

FIG. 6 is a flowchart describing an embodiment of the process for placing a telephone call included in FIG. 2.

FIG. 7 is a flowchart describing an embodiment of the process for making an Internet caller-ID message included in FIG. 2.

FIG. 8 is a diagram of one embodiment of an Internet caller-ID message.

FIG. 9 is a flowchart describing an embodiment of the process for delivering an Internet caller-ID message included in FIG. 2.

FIG. 10 is a flowchart describing an embodiment of the process of FIG. 9 for delivering an Internet caller-ID message using push technology.

FIG. 11 is a flowchart describing an embodiment of the process of FIG. 7 for delivering an Internet caller-ID message using instant messaging technology.

FIG. 12 is a flowchart describing an embodiment of the process receiving an Internet caller-ID message included in FIG. 2.

FIG. 13 is a diagram of the service flow of one embodiment of an Internet caller-ID system where the calling party provides a resource locator according to the present disclosure.

FIG. 14 is a diagram of the service flow of an embodiment of an Internet caller-ID system where the receiving party provides a resource locator according to the present disclosure.

FIG. 15 is a block diagram of one embodiment of a communication system of the present disclosure.

FIG. 16 is a flowchart of one embodiment of a method for establishing content delivery preferences.

FIG. 17 is a flowchart of one embodiment of a method for constructing and delivering content messages.

FIG. 18 is a flowchart of one embodiment of a method for providing consideration to a party for the assenting to the delivery of content messages.

FIG. 19 is one embodiment of an interface demonstrating delivery of a content message to a receiving party.

### DETAILED DESCRIPTION

One embodiment, among others, of the present disclosure provides a communication system and method, wherein during the time a caller or calling party is initiating a telephone call to a receiving party, an Internet caller-ID system is activated. The Internet caller-ID system notifies the receiving party of the identification of the calling party by an Internet caller-ID message. The Internet caller-ID message is delivered to an Internet-connected device of the receiving party, while the call is being completed over a telephone network. The telephone network may be a standard PSTN network or could be another telephone network such as voice over Internet protocol (VoIP).

### A. Architecture

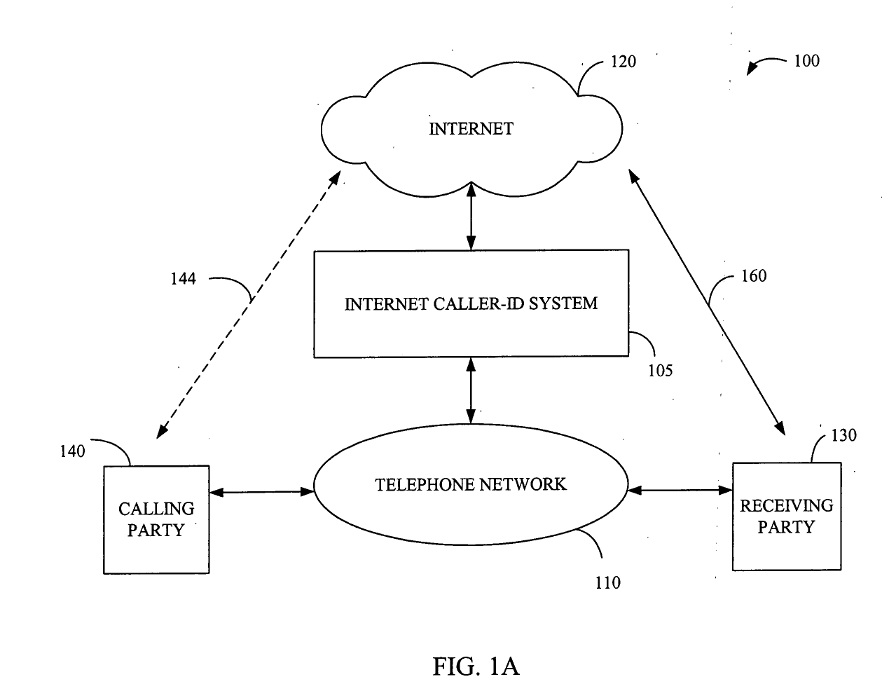

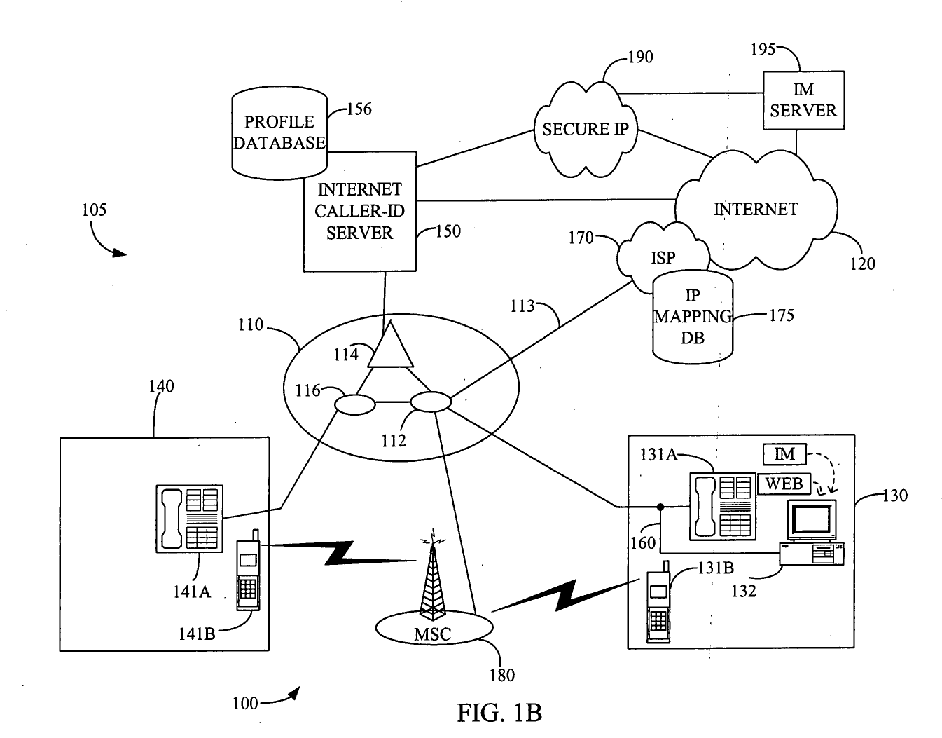

FIG. 1A is a block diagram showing one embodiment of a communication system 100 of the present disclosure. The system 100 includes an Internet caller-ID system 105, a telephone network 110, and the Internet 120. A communication station 130 of a receiving party is connected to the telephone network 110 and has an associated Internet access 160. Correspondingly, a communication station 140 of a calling party is also included in the communication system 100. The communication station 140 is connected to the telephone network 110, and it may have Internet access 144. Note, that although separation is suggested in FIG. 1A, discrete functions of the Internet caller-ID system 105 can be viewed as being performed by devices that are implemented in other elements, such as the telephone network 110 and by devices that are in implemented in the Internet 120, without limitations. Further, the Internet caller-ID system 105 can be implemented in software, firmware, hardware, or a combination thereof. In some implementations, functions are implemented in software or firmware that is stored in a memory as logic that is executed by a suitable instruction execution system.

FIG. 1B is a more detailed diagram of the communication system 100 of FIG. 1. Here, the Internet caller-ID system 105 includes telephone network switch 112, 116, a service control point (SCP) 114, and an Internet caller-ID server 150 with an associated profile database 156. The communication station of a receiving party 130 is shown connected to the telephone network switch 112 through connection 113, which provides access to the telephone network 110. The communication station of the receiving party may also have access to an Internet network 120 through an Internet service provider (ISP) 170. The communication station of a calling party 140 is connected to a telephone network switch 116.

The communication station of the receiving party 130 contains a telephony device connected to the telephone network and an Internet-connected device 132 that is connected to the Internet 120. Possible telephony devices include, among others, a telephone 131A attached to a telephone line from the telephone network or a wireless cellular telephone 1311B communicating to the telephone network through a mobile switching center 180. The Internet-connected device 132 includes a device for communicating on the Internet 120, such as a computer with Internet capabilities. The Internet-connected device 132 may be connected to the Internet 120 by a variety of manners 160. For example, the Internet-connected device 132 may be connected to a standard modem that converts data signals to voice signals and transmits the converted signals over the telephone line to the ISP 170 that has Internet access. In this sort of setup, however, the telephony device 131A and the Internet-connected device 132 would not be able to both be sending communication signals over one telephone line at the same time. Thus, both could not be “always-on,” unless a second telephone line was utilized.

Another manner for the Internet-connected device 132 to be “always-on” connected to the Internet 120 is for the Internet-connected device 132 to be connected to (or include) a DSL modem which allows the Internet-connected device 132 and the telephony device 131A to both communicate over a telephone line at the same time, so that both the telephony device 131A and the Internet-connected device 132 can be “always-on.” Also, the Internet-connected device 132 could be independently connected to the Internet 120 without the use of a telephone network phone line, by using a cable modem or by using satellite communications, as would be understood by one reasonably skilled in the art. Again then, simultaneous communications over the telephony device 131A and the Internet-connected device 132 would be possible.

The communication station of the calling party 140 includes a telephony device coupled to a telephone network switch 116, where the telephony device 141 may be a telephone 141A attached to a telephone line or a wireless cellular phone 141B communicating with the telephone network 110 through a mobile switching center 180.

The telephone network 110 provides telephone communication services and may be, among others, an analog PSTN network or a digital network, such as VoIP. The telephone network 110 features switches, such as switches 112, 116, within the network 110 which connect and route calls between the parties in a telephone conversation, such as between the calling party 140 and the receiving party 130. Also featured in the telephone network 110, a service control point 114 communicates with the switch 112, 116 and other devices, which may be located outside of the telephone network 110, in order to provide requested telephone services. The service control point 114 is a processing element capable of executing service logic.

Specifically, the Internet caller-ID server 150 communicates with the service control point 114 and the Internet 120 in order to provide Internet caller-ID service to users. In order to provide this service, other network devices such as an IP mapping database 175 that is provided by a ISP 170, and a profile database 156 communicating with the Internet caller-ID server 150 are employed. Further, an instant messaging server 195 may be utilized in the communication system 100, where the instant messaging server is connected to the Internet 120. These Internet connections and others throughout the communication system 100 may be protected by a secure IP network 190, as would be understood by one reasonably skilled in the art.

### B. Operation

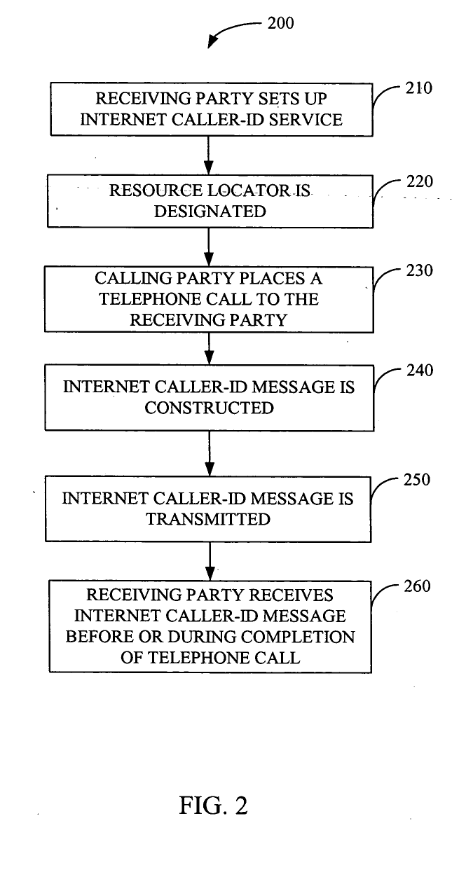

The overall operation of the communication system 100 will be described with reference to FIG. 2-11, which depict the functionality of an implementation of the Internet caller-ID system 100. It should be noted that, in some alternative implementations, the functions noted in the various blocks may occur out of the order depicted in the figures. For example, two blocks shown in succession in the figures may, in fact, be executed substantially concurrently or the blocks may be executed in reverse order depending upon the functionality involved.

Referring now to the flowchart of FIG. 2, one embodiment of the present disclosure includes a method 200 for sending and receiving caller-ID messages over the Internet. The process 200 involves a receiving party setting up Internet caller-ID service, as shown in block 210. In block 220, a resource locator is designated by a receiving party 130, a calling party 140, or a third party. In block 230, the calling party 140 places a telephone call to the receiving party 130. Then in block 240, an Internet caller-ID message is constructed, and transmitted to the receiving party 130, as shown in block 250. Accordingly in block 260, the receiving party 130 receives the Internet caller-ID message before or during the completion of the telephone call from the calling party 140 to the receiving party 130.

### 1. Setup

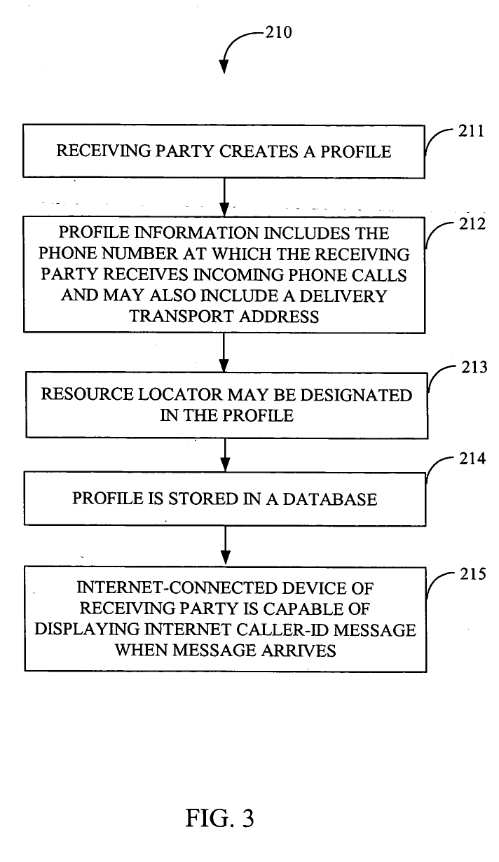

The operation of the setup process for an implementation of the Internet caller-ID system will be described with reference to FIG. 3. When a user, such as the receiving party 130, desires to register for the Internet caller-ID service, so that it may receive Internet caller-ID messages, the receiving party 130 first creates a profile, as shown in block 211. The creation of the profile can occur during a registration session for the Internet caller-ID service, where the receiving party 130 provides the information contained in the profile during an Internet session, telephone call, or an interview with a person who would later enter the information into the profile.

In block 212, the information gathered for the profile includes the phone number that the communication station of the receiving party 130 receives incoming phone calls at. This phone number may be the phone number of a telephone 131A attached to a phone line, or it may be even a wireless telephone 131B that the receiving party also uses at the communication station 131. Since multiple telephony devices 131 may be used to receive incoming phone calls, multiple phone numbers may be listed in the profile information for the receiving party 130. As depicted in block 212, the profile also contains the receiving party's 130 delivery transport address and any other information that is needed to deliver, over the Internet, the Internet caller-ID message to the Internet-connected device 132 of the receiving party. The delivery transport address is discussed in more detail later.

In block 213, the resource locator is designated. A resource locator is an address location for a document or media that is included in an Internet caller-ID message. Upon receipt, the receiving party's Internet-connected device 132 can retrieve the document specified by the resource locator. Note, the receiving party 130 may receive Internet caller-ID messages regardless of whether the calling party 140 has registered for the Internet caller-ID service or not. However, if the calling party 140 has registered for the Internet caller-ID service, then the calling party 140 may have the capability of designating a resource locator that is contained in the Internet caller-ID message.

For example, this resource locator could be a URL address for a personal web page of the calling party 140 that contains pictures that the calling party 140 wishes for the receiving party 130 to view. Also as part of the calling party's profile, the calling party 140 may provide additional information such as the calling party's name, address, and any other information that can be placed in the Internet caller-ID message. The profiles are stored on a profile database 156. The profile database 156 is connected to or stored as part of the Internet caller-ID server 150, as shown in block 214.

If the calling party 140 does not designate a resource locator, or if the calling party 140 is not registered with the Internet caller-ID service, then a default resource locator, such as the calling party's entry in the white or yellow pages, may be selected as the resource locator. It is also contemplated that the receiving party 130 may designate a resource locator that is contained in the Internet caller-ID message, or a third party who is not a participant in the telephone communication may designate a resource locator. These steps and features are discussed subsequently herein.

The Internet-connected device 132 of the receiving party should have the capability of displaying the Internet message being sent as soon as it arrives. Therefore in block 215, the Internet-connected device 132 is set to be able to receive messages. For example, if the Internet caller-ID message is in the form of a web page, the Internet-connected device 132 should have a web browser installed and active on the Internet-connected device. Likewise, if the message is in the form of an instant message, the Internet-connected device 132 should have an instant message client loaded and actively running on the Internet-connected device 132.

### 2. Designating the Resource Locator

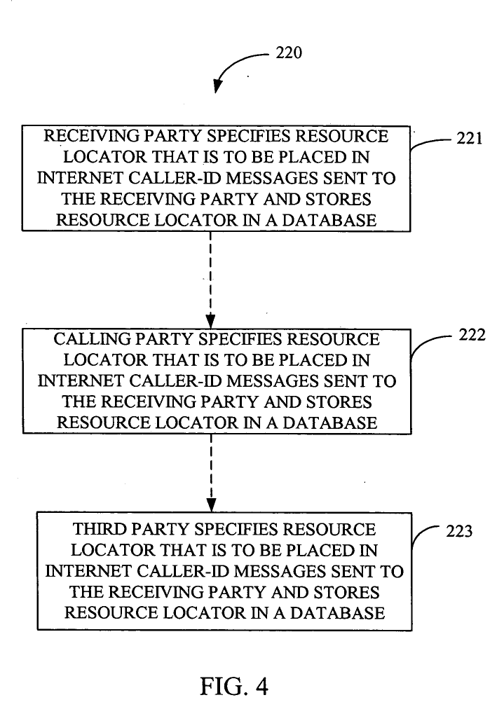

As previously stated, the resource locator designations are kept in the profile database 156. The profile database 156 may be protected by a secure IP network 190 and could also be contained in the Internet caller-ID server 150. Each resource locator is an address for a resource or document that may be retrieved by the recipient of an Internet caller-ID message and is associated with a phone number or phone numbers of the receiving party or calling party. The resource locator may be specified by a URL address (with # replaced) like http://#.net/me.htm or file://businessfile.txt. Since more than one resource locator could be contained in the message, a party may designate more than one resource locator to be contained in the message, or multiple parties may separately designate resource locators. For example, a receiving party 130, a calling party 140, or a third party may designate a multitude of resource locators that may be contained in the Internet caller-ID message. Therefore in the profile database 156, both the calling party and the receiving party may have resource locators designated that can be placed in the Internet caller-ID message. FIG. 4 is a flowchart depicting an embodiment of the process for designating a resource locator 220 and is discussed further below.

### a. Receiving Party

As part of registering to the Internet caller-ID service, a receiving party 130 may have the capability of designating resource locators for the caller-ID messages it receives. Therefore, as shown in block 221, the receiving party could provide a resource locator and have this information stored in the receiving party's profile in the profile database 156. For instance, the receiving party may keep a database of customer records that are organized by a customer's phone numbers. Therefore, in the receiving party's profile, the receiving party 130 could designate the parameterized URL http://#.mypage.net/records.html?CN=CallingDN as a resource locator, where the portion of the URL information indicated by “CallingDN” is replaced by the Internet caller-ID server 150 with the calling party's telephone number in the Internet caller-ID message. Accordingly, for each phone number that calls the receiving party, the receiving party will have instant access to a unique business record for that phone number.

### b. Calling Party

If the calling party 140 has registered for the Internet caller-ID service, he or she may also have the ability to designate resource locators that are contained in the Internet caller-ID messages that are triggered by the calling party's 140 phone calls. For example in block 222, the calling party 140 may provide, as part of its profile to the profile database 156, the resource locator that it would like made available to a receiving party 130 it is calling. The calling party's resource locator designation may point to a multitude of objects, including a personal web page of the calling party 140 or a favorite music file that a receiving party 130 could access by activating the resource locator in the message.

If a receiving party does not have a preexisting web page to specify, then the Internet caller-ID service could provide as part of its profile setup, the option of filling out a form and having a web page automatically created for the user. If the calling party is not registered for Internet caller-ID service or if a resource locator has not been stored in the profile database 156 for a particular telephone number, a resource locator could still be contained in the message that pertains to the calling party 140: As a default, the message could provide a standard link to the receiving party's 130 listing in an on-line telephone directory, such as in the white or yellow pages, where the telephone directory listings are kept in a database in the telephone network 110.

### c. Third Party

An Internet caller-ID message may additionally contain a resource locator that is designated by a third party, perhaps at the permission of either the receiving party 130 or calling party 140. For example, a receiving party 130 or calling party 140 may separately agree with a third party that that the third party may add a resource locator to an Internet caller-ID message by storing a resource locator associated with the party's phone number in a profile database 156 for one of the parties having a profile, as depicted in block 223. For example, the receiving party 130 may agree to let a third party announce updates or news pertaining to the third party's website through the caller-ID messages that the receiving party 130 receives. Likewise, a third party may want its announcements to go out on the Internet caller-ID messages that a calling party 140 initiates through its outgoing calls. Therefore for this benefit, a third party may reimburse the receiving party 130 or calling party 140 in the form of, possibly, monetary consideration, subsidizing telephone services, such as the Internet caller-ID service fee, or providing third party services to the calling party 140. Additionally, a receiving 130 or calling party 140 may prefer to have a resource locator be designated by a third party without consideration. For example, a party may be inclined to have a daily horoscope or weather report be provided by the resource locator in the Internet caller-ID messages it sends or receives.

In order to designate the resource locator, the third party could be provided access to the profile database 156 so that the third party would have the ability to store a resource locator in the receiving party's 130 or calling party's 140 profile. Accordingly, in one embodiment of this process, the third party makes an agreement with the provider of the Internet caller-ID service for the ability to add resource locator entries to the profile database 156. In another embodiment of the process, the third party could have a web site whereby a party that is registered for the Internet caller-ID service could assent to the addition of resource locators to the registered party's profile, where the resource locators are designated by the third party.

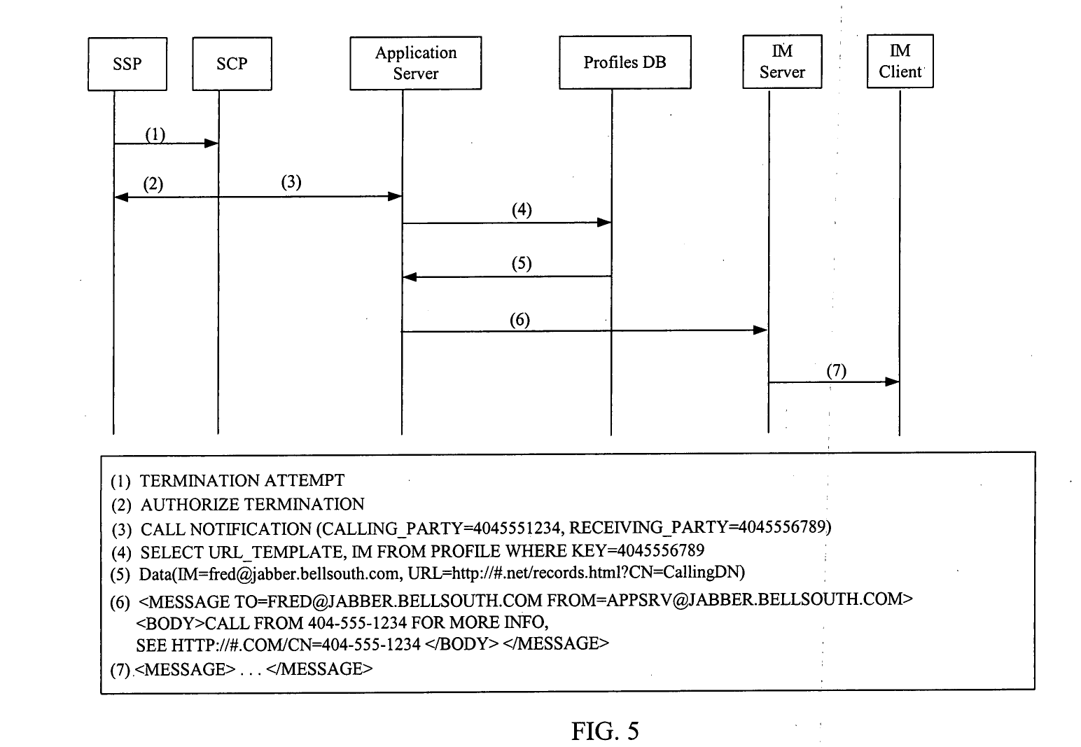

FIG. 5 is a flowchart representation of one implementation of the supplying of third party announcements in the Internet caller-ID messages of a registered party. In block 610, a receiving party or a calling party registers for Internet caller-ID service. In block 620, the registered party assents to the placement of third party announcements in the registered party's Internet caller-ID messages, and in block 630, the registered party is reimbursed by the third party. Typically, a registered party would assent by verifying (e.g., clicking a VERIFY button on the web page) that the registered party agrees to the inclusion of the resource locators concerning third parties in its Internet caller-ID messages. Accordingly, the third party and the Internet caller-ID provider may have an agreement already established, where the Internet caller-ID provider has given the third party the ability to write to the profile database 156.

Alternatively, the Internet caller-ID service provider may have an arrangement in place with a third party, whereby a party registered for the caller-ID service also agrees to allow the Internet service provider to include resource locator(s) to the registered party's profile. The included resource locator(s) could be a URL to a web site hosted by the third party or possibly a web page describing a service or product offered by the third party. In return for agreeing to the inclusion of the resource locator, the Internet service provider could be reimbursed by the third party, and the registered party could be reimbursed by the third party or even the Internet service provider.

### 3. Placing the Call

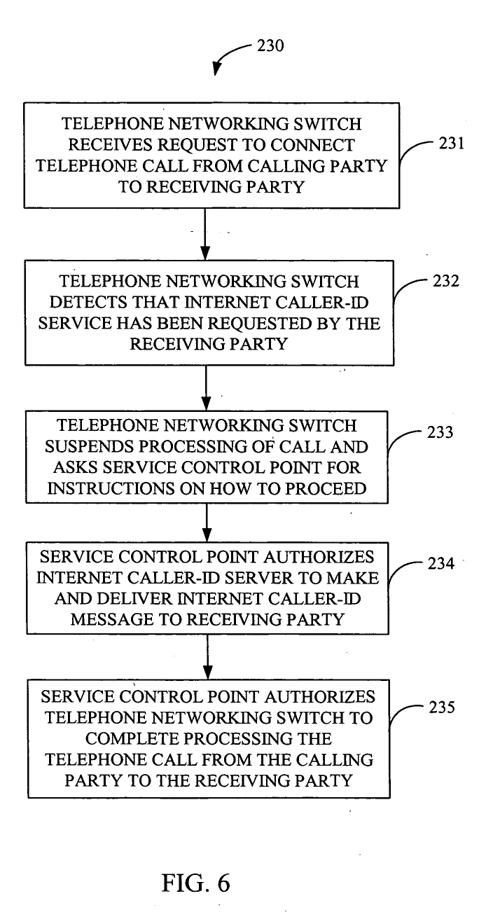

In block 230, the calling party 140 places the telephone call to a receiving party 130. Within the telephone network 110, representative switches 112, 116 are utilized to route calls between points or destinations within the telephone network 110. Associated with telephone calls are services such as call-waiting, call-forwarding, and the conventional caller-ID. When a switch 112 identifies that a service has been requested by either the telephone number originating the call or the telephone number receiving the call, the switch 112 suspends processing of the call and forwards information about the call to a service control point 114, such as a SCP in a signal system 7 (SS7) network or a softswitch in a digital VoIP network. The service control point 114 recognizes the type of service requested from the telephone number and informs the switch 112 on how to handle the call. For example, FIG. 6 shows an embodiment of this process of the present disclosure. In block 231, the switch 112 servicing the calling party 140 receives the request for a connection to be made to the telephone number of the receiving party 130. In block 232, the switch 112 detects that a telephone service has been requested. The switch 112 asks the service control point 114 on how to proceed and temporarily suspends normal call processing, as shown in block 233. The service control point 114 then authorizes the Internet caller-ID server 150 to make and deliver an Internet caller-ID message, as shown in block 234. In block 235, the service control point 114 tells the switch 112 to start processing the call again.

### 4. Generating the Message

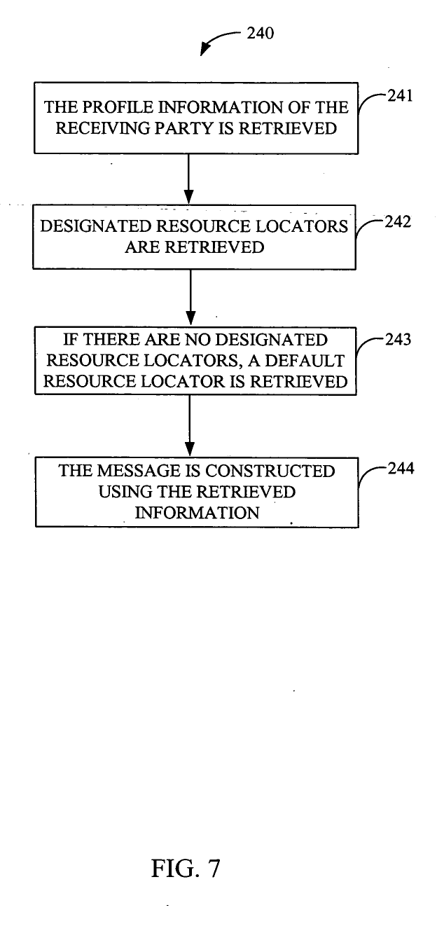

FIG. 7 is a flowchart depicting an embodiment of a process for generating the Internet caller-ID message 240. In block 241, with the service control point's 114 authority, the Internet caller-ID server 150 retrieves the profile information of the receiving party 130, which includes the receiving party's delivery transport address. Additional information such as the caller's name, time, date, and the caller's home address may also be retrieved from the profile database 156 or other databases in the telephone network. Further in block 242, the Internet caller-ID server 150 retrieves the resource locator(s) from the profile database 156 that are to be included in the Internet caller-ID message. If a resource locator is not designated for a particular number in the profile database 156, then in the message, a default resource locator may be provided, such as an Internet address for a online white or yellow page listing of the calling party, as depicted in block 243. With this collected information, the Internet caller-ID message may be constructed 240, as shown in block 244.

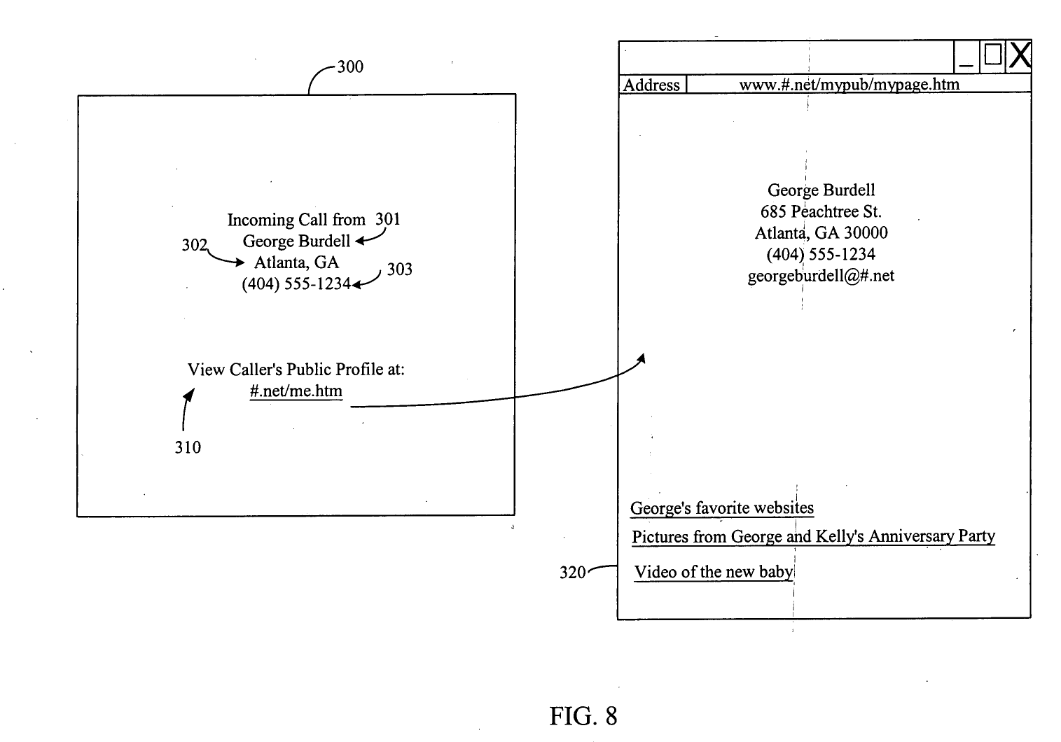

FIG. 8 shows a representation of one example, among others, of the content that is contained in an Internet caller-ID message for one embodiment of the present disclosure. One portion of the illustration approximates an instant message display 300 that the internet-connected device 132 of the receiving party would display. As shown, the instant message display 300 may comprise the name 301, address 302, and phone number 303 of the calling party, along with a resource locator 310. The other portion of the illustration approximates the web browser display 320 that would appear when the receiving party activates the resource locator 310 (or “link”) imbedded in the instant message. In this example, the resource locator 310 is an Internet URL of a web page 320 hosted by the calling party 140.

### 5. Delivering the Message

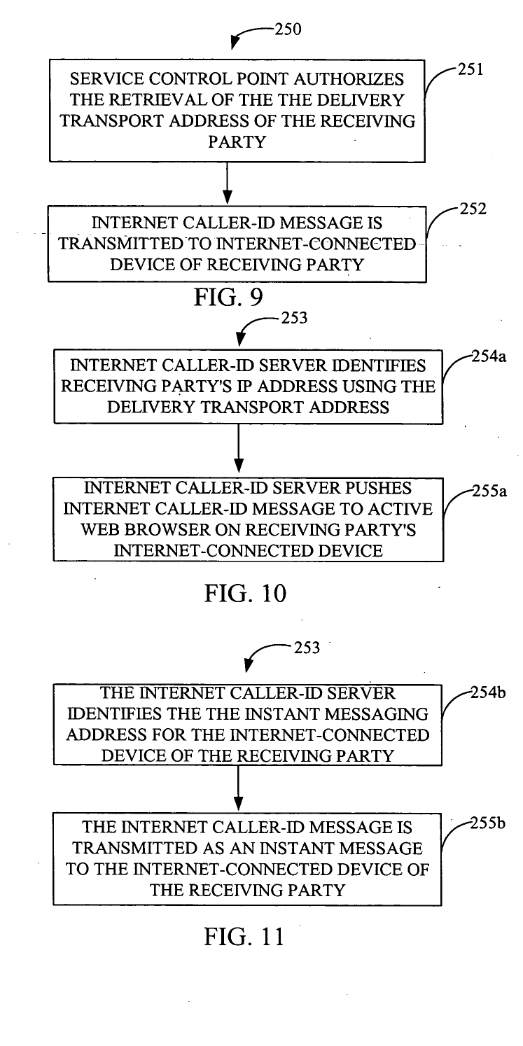

FIG. 9 is a flowchart depicting an embodiment of a process for delivering the Internet caller-ID message 250. With the receiving party's delivery transport address, the service control point 114 authorizes the Internet caller-ID server 150 to retrieve the profile information for the receiving party 130. The profile information is retrieved from the Internet caller-ID profile database 156 via the Internet caller-ID server 150, as depicted in block 251. The Internet caller-ID server 150 uses the delivery transport address to send the Internet caller-ID message over the Internet to the Internet-connected device 132 of the receiving party, as shown in block 252.

### a. Push Technology

FIG. 10 depicts one exemplary embodiment of a process for delivering an Internet caller-ID message 250 using push technology. In block 254a, the Internet caller-ID server uses the delivery transport address to determine the IP address of the Internet-connected device 132. This may occur in a number of ways. For example, the identity of the receiving party's ISP may be the provider of the receiving party's phone services and therefore may be known to the Internet caller-ID server 150. Alternatively, the identity of the ISP 170 may be provided in the receiving party's profile and then may be obtained at the same time that the Internet caller-ID server 150 retrieves the receiving party's 130 delivery transport address. After obtaining the identity of the ISP 170, the Internet caller-ID server 150 could request the IP address from an IP mapping database 175, where the IP mapping database 175 is maintained by the personal ISP 170 of the receiving party.

For instance, whenever the receiving party 130 logs in to its ISP 170 it is dynamically allocated an Internet address by the ISP 170. When the receiving party 130 logs off and discontinues its Internet session, the Internet address is reallocated and is no longer associated with the receiving party 130. Accordingly, the next time the receiving party 130 logs in to its ISP 170 it will receive another address that is highly likely to be different than the previous IP address. Therefore, the IP mapping database 175 stores all the current IP addresses for the active users of the ISP 170. The Internet caller-ID server requests and receives the current IP address from the ISP 170, where the ISP 170 retrieves the information from the IP mapping database 175. In block 255a, after obtaining the current IP address, the Internet Caller-ID server “pushes” the Internet caller-ID message, in the form of a web page, over the Internet, to an active web browser loaded on the Internet-connected device 132.

Please note, in the most general sense, delivery of an Internet caller-ID message can be accomplished using a low level protocol like TCP or UDP. For example, if the address of the receiving party's Internet-connected device 132 is designated as the delivery transport address of the receiving party 130, the internet caller-ID server 150 could initiate a connection to the receiving party's Internet-connected device 132 and communicate the internet caller-ID message to the receiving party 130.

### b. Instant Messaging

Another exemplary embodiment of a process of delivery is depicted in FIG. 11. Here, instant messaging technology is used. In block 254b, the instant messaging address for the receiving party's Internet-connected device 132 is determined using the delivery transport address. For example, the delivery transport address may be the receiving party's instant messaging address, such as fred@jabber.bellsouth.com. With the progression toward an open and interoperable instant messaging protocol, such as the XML based instant messaging system Jabber, this may be all that is needed to deliver an instant message to the receiving party, since an instant message could be addressed in the same fashion as an email address.

In a closed environment, the delivery transport address could be the name of the receiving party's instant messaging userID or nickname. Therefore, the receiving party's instant messaging provider would also be provided in the receiving party's profile with any other information that may be needed. Accordingly, the Internet caller-ID server 150 may authenticate itself to the instant messaging service 170 and act as a surrogate or proxy client on the server. In this manner, the Internet caller-ID server can send instant messages to the receiving party 130.

Therefore, in block 255b, the Internet caller-ID message is transmitted as an instant message to the Internet-connected device 132 of the receiving party. The active instant messaging client installed on the Internet-connected device 132 receives and displays the Internet caller-ID message. Typically, the instant messaging client will be already installed and running on the Internet-connected device 132 before an Internet caller-ID message is sent.

### 6. Receiving the Message and Telephone Call

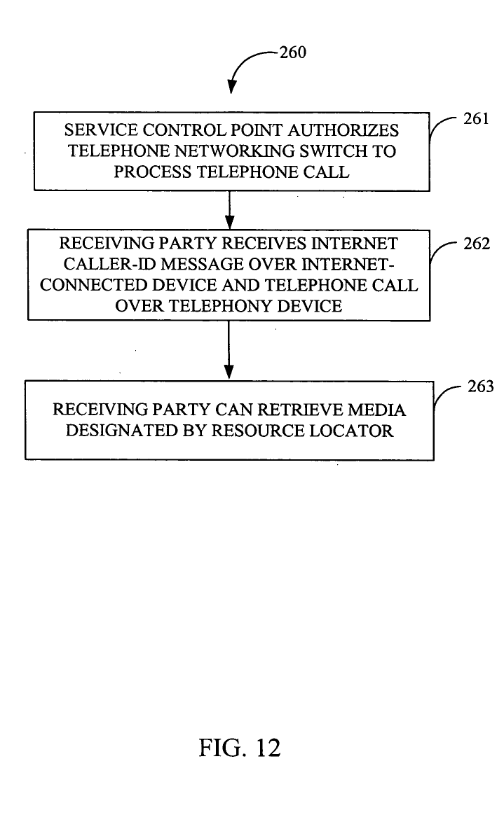

FIG. 12 depicts an embodiment of a process 260 for receiving the Internet caller-ID message and completing the telephone call from the calling party 140 to the receiving party 130. In block 261, after the service control point 114 authorizes the Internet caller-ID server 150 to send the Internet caller-ID message, the service control point 114 authorizes the switch 112 to proceed with completing the calling party's 130 telephone call to the receiving party 140. Hence in block 262, the receiving party 130 receives an Internet caller-ID message on its Internet-connected device 132 at about the same time that it receives a telephone call on its telephony device 131. The receiving party 130 reads the Internet caller-ID message to see who is calling. Additionally, the receiving party 130 can also activate any of the resource locator(s) 350 provided before, during, or after the call is completed, as shown in block 263. Further, if the call is not answered by the receiving party 130 party, the receiving party 130 can still access the resource locator 350 that is contained in the Internet caller-ID message.

### C. Flow Diagrams

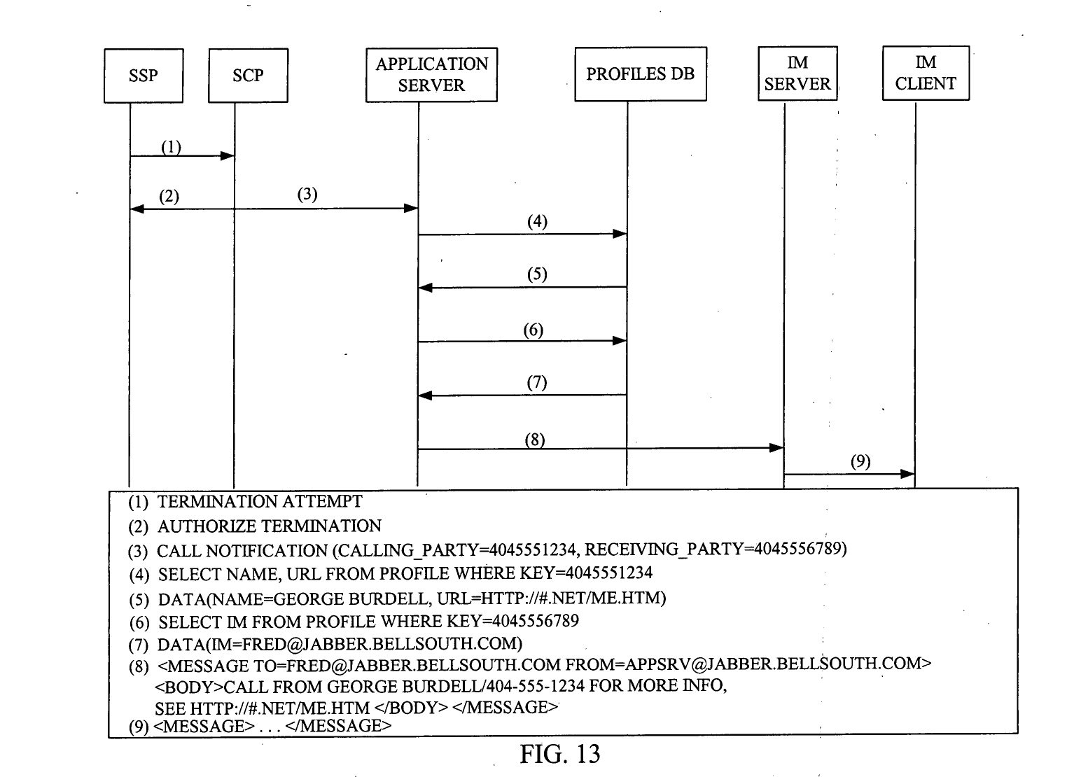

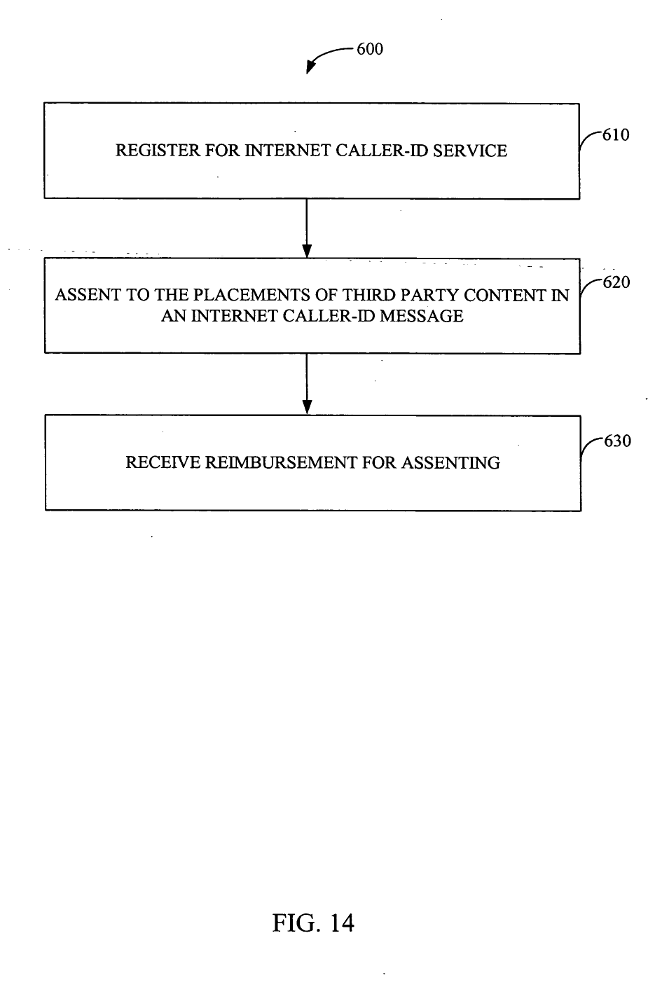

FIGS. 13 and 14 show service flow diagrams for implementations of the present disclosure. The diagram of FIG. 13 specifically shows an example service flow for an embodiment of the present disclosure as would be provided to a PSTN subscriber. In this scenario, the subscriber is the receiving party 130 at the phone number 404-555-6789. This example illustrates a variety of the service in which the calling party 140 defines the resource locator 310 that is to be sent with each call. For this example, it is assumed that the resource locator is in the form of a URL; and the calling party 140 and the receiving party 130 are both represented in a subscriber profile database record which provides common profile information. This information includes at least the following: name, URL, instant messaging address. The application logic resides in the application server 150 (Internet caller-ID server) and implements functionality that allows it to appear as a regular user to an instant messaging server 190. This is known as a surrogate or proxy client. The surrogate/proxy client has connected and authenticated itself to the instant messaging service 170 prior to the initiation of this call scenario.

The call is first presented to the telephone networking switch 112, which is an service switching point (SSP) in a signaling system 7 (SS7)/PSTN advanced intelligent network (AIN) 110, where the SSP 112 hosts the receiving party subscriber line. The subscriber line is provisioned with an AIN termination attempt trigger. Upon encountering the trigger, the SSP 112 will send (1) a TERMINATION ATTEMPT (TAT) query message over the SS7 network 110 to a SCP (service control point) 114 where an AIN trigger handling logic resides. Note, the use of AIN triggers is for example only, other mechanism exists for triggering on an inbound call. For example, in a voice over IP environment, the service could be triggered upon receipt of a session initiation protocol (SIP) invite message by a SIP proxy server.

Upon receipt of the TAT query, the SCP 114 will immediately respond to the SSP 112 with (2) an AUTHORIZE TERMINATION message. In conjunction with this message, the SCP 114 will send a (3) Call Notification message to an application server 150 in which the Internet caller-ID service application logic resides. There are several possible alternate implementations to the form of this notification. The notification could be accomplished using a distributed procedure call mechanism such as CORBA or Java RMI, or it could be transmitted via an ordinary TCP or UDP connection. It is assumed that a variety of methods would be apparent to someone of ordinary skill in the art.

Note, the distinction between SCP (service control point) 114 and the application server (Internet caller-ID server) 150 is a logic distinction. It is not necessary that the functions be provided by separate network elements. It is possible to realize an implementation of this service where the trigger handling logic and application logic are provided by the same application within the same network element.

Upon receipt of the Call Notification (3) message, the application logic will query a database 156 to determine the resource locator and name of the caller, and the instant messaging address of the subscriber. These transactions are show in flows 4-7. In this example, the profile database 156 is assumed to be a relational database implementing the SQL query language. However, the specific representation of the profile database 156 is not important. Alternate implements should be apparent using a number of different access and storage methods. One such example is the use of remote directory server implementing the light-weight directory access protocol (LDAP).

After retrieving the needed information from the profile database 156, the application service logic in the Internet caller-ID server 150 will build and send an instant message (8) to the instant messaging server 190. Upon receipt of the message, the instant messaging server 190 will forward the message (9) to the receiving party's instant messaging client 132. In this example, we have elected to show an interaction with Jabber—an open source instant messaging service defined using XML. Jabber provides at least one widely available instant messaging client that presents URL information in an active form. That is, it allows the user to mouse-click on the URL and open a browser session and view the HTML content. Implementations using other instant messaging services should be apparent to one of ordinary skill in the art.

The diagram of FIG. 14 shows an alternative implementation in which the resource locator information is not under the control of the calling party 140 but is, instead, provided in the form of a template which may be under the control of the subscriber 130 (receiving party). The call flow is identical to the previous flow except that information about the calling party 140 is not retrieved. Instead, when the resource locator information is retrieved from the receiving party 130 profile, the portion of the URL information indicated by “CallingDN” is replaced with the calling party's telephone number in the Internet caller-ID message. All other elements of the service are as described above. The URL syntax is for example only.

This form of the embodiment, among others, of the disclosure allows the calling party to control the information being provided. It could be used to allow a user to bind access to their own web content to inbound calls. For example, a user might elect to have a web front end to a customer relationship management package. The URL template could be constructed such as to allow access to this web based system.

The enhanced visual capabilities of the above-described embodiments of the present disclosure advantageously leads to an improved system and method for providing a full set of information about the maker of a telephone call. The information delivered may be contained in a web server, based on content created by the calling party prior to the call, or other information, such as announcements from third parties. It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the principles of the disclosure. For example, it is contemplated that an embodiment of the present disclosure will include the features of conventional caller-ID services in addition to the new features discussed herein. Therefore, under the principles of the present disclosure, standard caller-ID features such as caller-ID blocking are contemplated. Accordingly, it will be understood by those skilled in the art that the present disclosure is not limited to the specific implementations shown in the figures. For example, information stored in separate databases in one embodiment of the disclosure could be collectively be stored in a single database in another embodiment of the disclosure. Further, other Internet transport mediums, such as email and or SMS messaging, may be used to deliver the Internet caller-ID messages.

### D. Alternative Embodiments

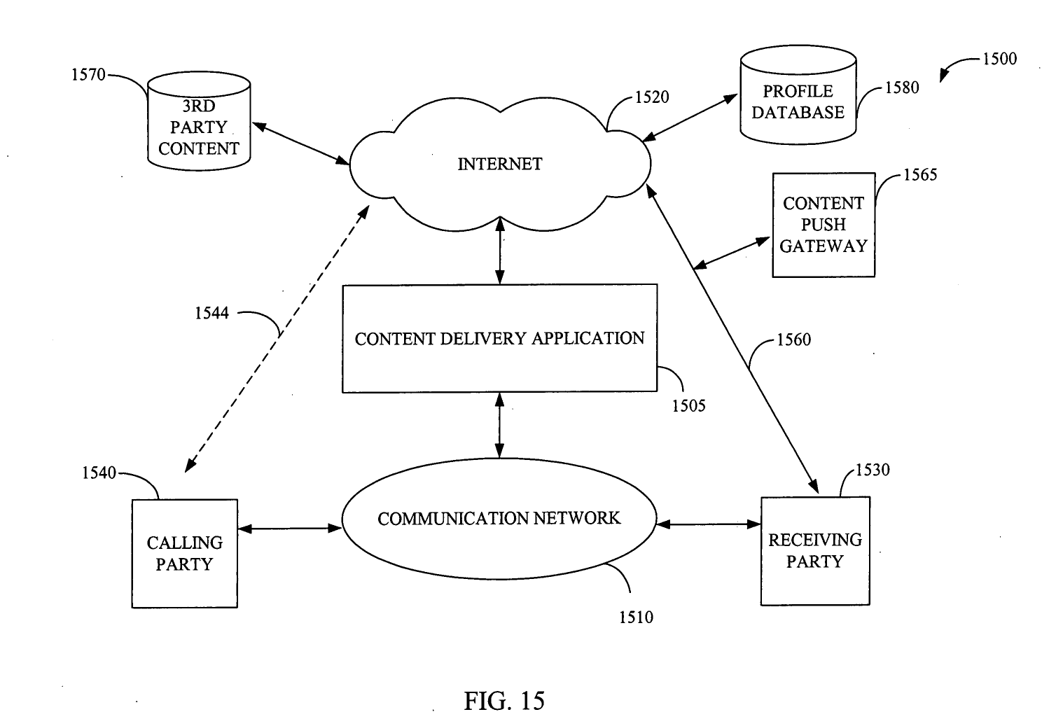

Next, in FIG. 15, a block diagram of another embodiment of a communication system of the present disclosure is shown. The communication system 1500, in FIG. 15, includes a communication network 1510 (e.g., a telephone network, a messaging network, etc.) and the Internet 1520. The communication device 1530 of a receiving party is communicatively coupled to the communication network 1510 and has access 1560 to the Internet 1520. The communication network 1500 further includes a content delivery application 1505. The content delivery application 1505 transmits information to a communication device 1530 of a receiving party. In particular, the content delivery application 1505 constructs a content message including third party content and sends the content message to the receiving party via a content push gateway 1565. From the Internet 1520, the content push gateway 1565 receives a content message from the content delivery application 1505 and formats the message for transmission to the particular communication device 1530 of the receiving party (e.g., a Caller-ID box, a personal digital assistant, a cellular telephone, SMS receiver, web browser, etc.).

Correspondingly, a communication device 1540 of a calling party is also included in the communication system 1500. The communication device 1540 is connected to the communication network 1510, and it may have Internet access 1544. Note, that although separation is suggested in FIG. 15, discrete functions of the content delivery application 1505 can be viewed as being performed by devices that are implemented in other elements, such as the communication network 1510 and by devices that are in implemented in the Internet 1520, without limitations. Further, the content delivery application 1505 can be implemented in software, firmware, hardware, or a combination thereof. In some implementations, functions are implemented in software or firmware that is stored in a memory as logic that is executed by a suitable instruction execution system. A third party database 1570 is accessible from the Internet 1520 and stores content to be delivered to the receiving party in a content message. Further, a profile database 1580 is accessible from the Internet and is used to store profile information for the receiving party that may include a phone number or address, content preferences, and content delivery address. For example, based upon content preferences specified in the receiving party's profile, content is selected to be included in a content message for the receiving party. Therefore, the content message is customized for a particular receiving party, in some embodiments, and is transmitted to the content delivery address.

For some embodiments, when a user, such as the receiving party 1530, desires to register for the content delivery service, so that it may receive content messages, the receiving party 1530 first creates a profile, for some embodiments. The information gathered for the profile may include the phone number that the communication device of the receiving party 1530 receives incoming phone calls at. This phone number may be the phone number of a telephone attached to a phone line, or it may be even a wireless telephone that the receiving party also uses. Therefore, the communication device 1530 of the receiving party may receive telephone calls from a wire-based or a wireless communication network 1520. Since multiple telephony devices may be used to receive incoming phone calls, multiple phone numbers may be listed in the profile information for the receiving party. When the receiving party receives an incoming telephone call, additional information from a third party is also delivered (e.g., “piggy-backed”) to the receiving party with the incoming phone call along with caller identification information.

Thus, pre-specified preferred information to a receiving party can be delivered along with an incoming call attempt. As such, various embodiments of the present disclosure delivers information to a receiving party on a periodic basis (as frequently as incoming phone calls or messages arrive) when the receiving party is being alerted of another incoming communication. Moreover, preferred information is provided in such a way as to offer the opportunity for the third party to provide consideration to the receiving party (in the form of discounts, coupons, payments that subsidize the cost of the communication service (e.g., telephone service, messaging service, etc.) to the receiving party, or other compensation.

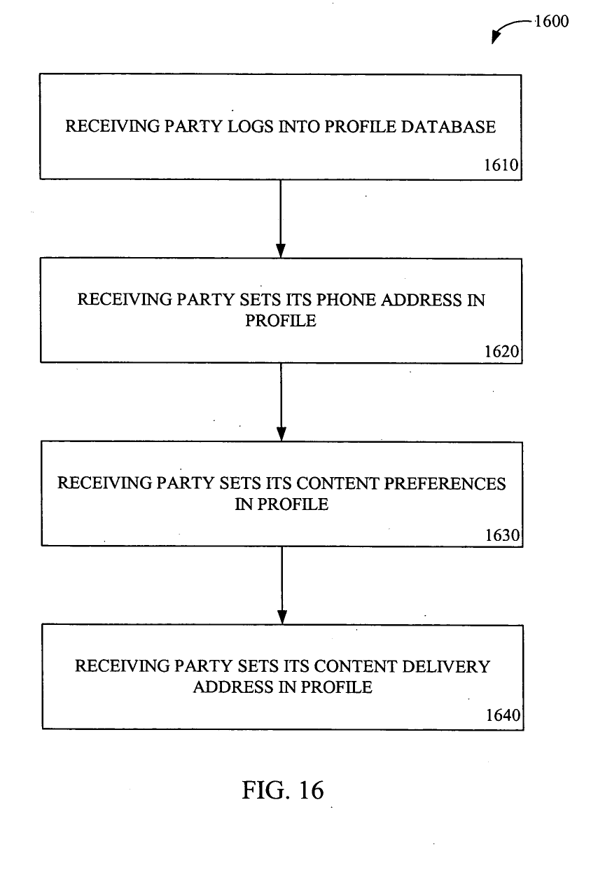

FIG. 16 is a flowchart of one embodiment of a method for establishing content delivery preferences. The process 1600 involves a receiving party logging (1610) into a profile database and setting (1620) their telephone address in a profile for the receiving party (e.g., by accessing a registration system via the World Wide Web, an interactive voice response unit, etc.). Next, the receiving party sets (1630) their content preferences in the profile. For example, the content preferences may specify categories of information that the receiving party is willing to receive over a communication device, such as weather reports, entertainment news, stock information, etc. Further, the receiving party sets (1640) their content delivery address in the profile. The content delivery address is the address where content messages are sent. For example, for a personal communication device that has both a phone number and a text messaging email address, the content delivery address may be specified to be the text messaging email address for the personal communication device. In other embodiments, content delivery addresses also include a variety of messaging formats, such as instant messaging addresses, short message service addresses, telephone numbers, Internet Protocol addresses, etc.

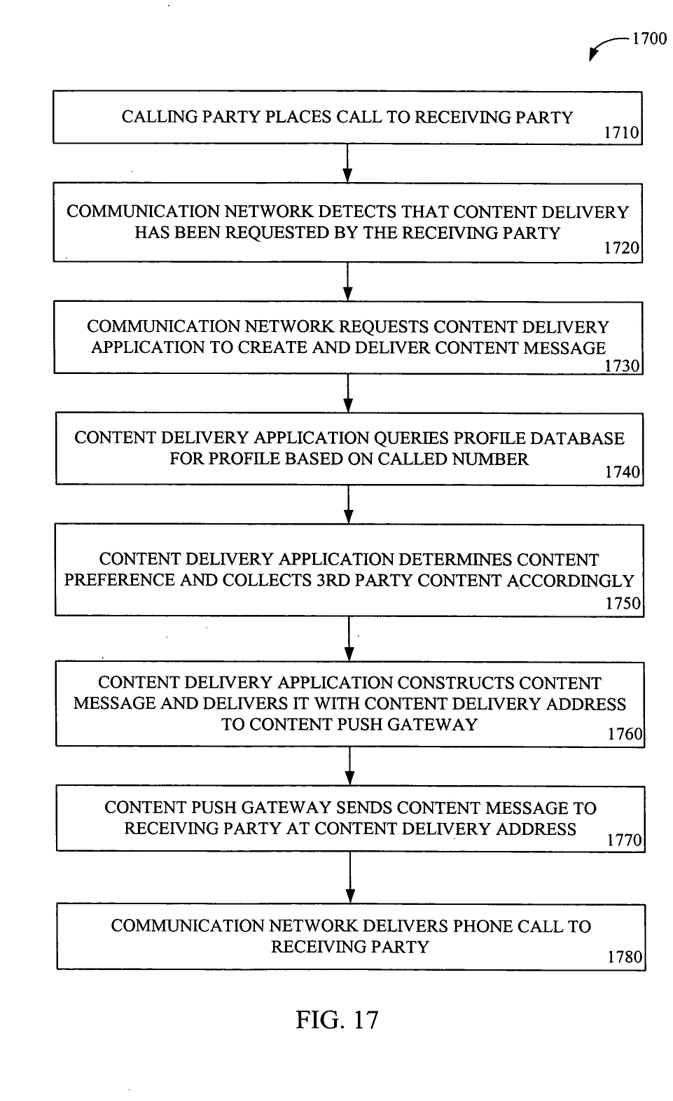

With access to the receiving party's content delivery address, the communication network 1510 can detect a telephone call being sent to the receiving party and utilize the content delivery address of the receiving party to send caller identification information along with additional information to the receiving party at the content delivery address. FIG. 17 depicts one exemplary embodiment of a process for delivering a content message using push technology. In block 1710, a calling party places (1710) a telephone call to a receiving party. The communication network detects (1720) that content delivery has been requested by the receiving party.

The communication network then requests (1730) the content delivery application to create and deliver a content message. The content delivery application queries (1740) the profile database for a profile based on the called number. From the retrieved profile, the content delivery application determines (1750) content preferences and collects third party content accordingly. The content delivery application constructs (1760) the content message in the proper format for the respective content delivery address (e.g., short message service format, wireless markup language, hypertext markup language, etc.) and delivers the content message with the content delivery address to a content push gateway. The content push gateway then sends (970) the content message to the receiving party at the content delivery address. Also, the communication network delivers (980) the telephone call to the receiving party.

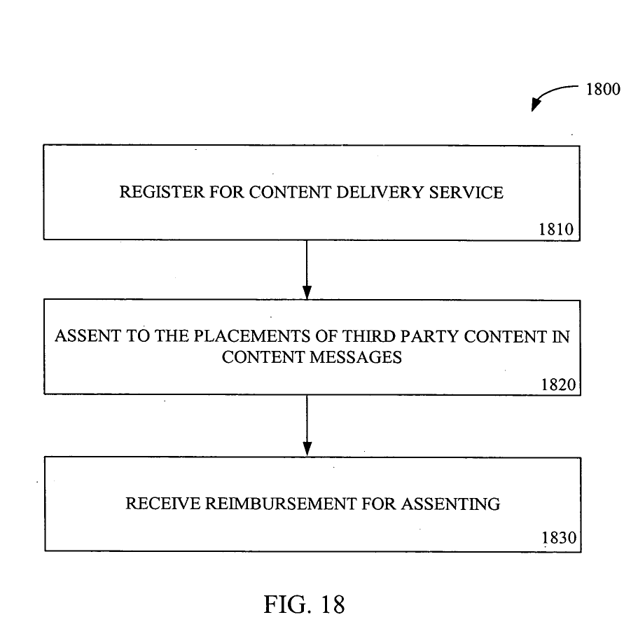

FIG. 18 is a flowchart representation of one implementation of the supplying of third party announcements in the content messages of a registered party. In block 1810, a receiving party registers for content delivery service that supplies content messages. As part of the registration process, the receiving party may specify the particular advertisers or types of advertising that would be preferred to be received in content messages. In block 1820, the registered party assents to the receipt of third party content via content messages, and in block 1830, the registered party is reimbursed by the third party for agreeing to register for the content delivery service and receipt of third party content. Typically, a registered party would assent by verifying (e.g., clicking a VERIFY button on a registration web page) that the registered party agrees to the inclusion of the content message from a third party. In doing so, consideration could be provided to the registered party. For example, consideration may be provided to subsidize the cost of communication services to the registered party. Alternatively, consideration in the form of a coupon of a product offered by the third party may be provided, for example. In addition, consideration could also be provided to the content delivery service by the third party.

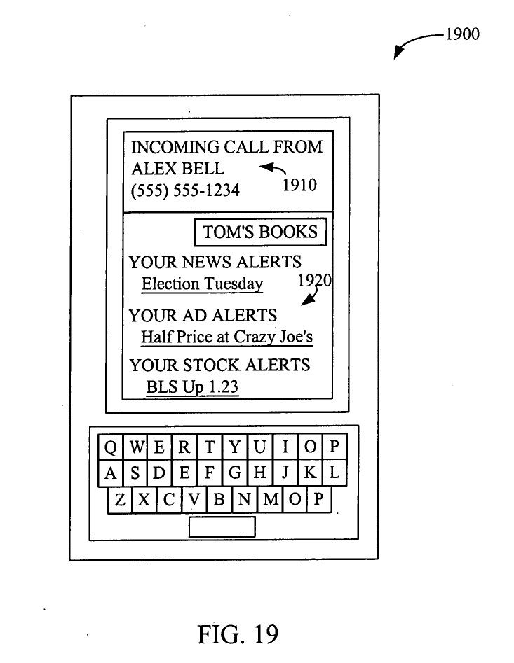

Next, FIG. 19 shows one embodiment of an interface demonstrating delivery of a content message to a receiving party. In the example of FIG. 19, a representation 1900 of a mobile personal communication device is shown. This particular representation 1900 is intended to support wireless networks, such as Code Division Multiple Access (CDMA) and Global System for Mobile Communications (GSM), and a variety of communication formats, including voice communication over telephone network, short message service (SMS), multimedia message service (MMS), wireless application protocol (WAP), electronic mail (e-mail), etc. In the example of FIG. 19, the mobile personal communication device 1900 (e.g., a Blackberry® messaging phone) has received information 1910 about the calling party making an incoming call to the personal communication device. In addition, the mobile communication device has also received customized third party content 1920. Since a user is likely to check identification information of a caller of an incoming telephone call, the user is also increasingly likely to view additional information that is appended to the caller identification information. Thus, this is an effective way to distribute content information to a user and for a user to dictate the nature of the content that he or she prefers to receive. For example, there may be specific retail stores or other businesses with which the receiving party normally does business. Accordingly, the receiving party would prefer to receive advertising from their preferred businesses as opposed to a random list of businesses, making the utility of the information that is delivered to the receiving party greater. Likewise, there may be preferred types of timely information that the receiving party would like to receive, e.g., entertainment news, local news, stock information for specific stocks, and weather information for their hometown. Accordingly, all such modifications and variations are intended to be included herein within the scope of the disclosure and the present disclosure and protected by the following claims.

1. A method for sending content associated with a communication to a receiving party of the communication, the method comprising the steps of:
receiving content preferences of the receiving party;
receiving a communication attempt to be sent to the receiving party;
determining the content preferences for the receiving party;
constructing a content message including the content according to the content preferences; and
sending the content message to the receiving party.

2. The method according to claim 1, wherein the step of receiving content preferences comprises the receiving party setting up a profile via the Internet.

3. The method according to claim 1, wherein the step of receiving a communication attempt comprises an incoming phone call attempt.

4. The method according to claim 1, wherein the step of determining content preferences comprises accessing a profile.

5. The method according to claim 1, wherein the content preferences specify preferred advertisers or types of advertisers.

6. The method according to claim 1, wherein the content preferences specify preferred types of news or other timely information.

7. The method according to claim 1, wherein the sending of the content message is via an email.

8. The method according to claim 1, wherein the sending of the content message is via an instant message.

9. The method according to claim 1, wherein the sending of the content message is via pushing a web page to a content delivery address.

10. A method for providing consideration to a party in exchange for acceptance of content associated with a communication to a receiving party, the method comprising the steps of:
receiving content preferences of the receiving party;
receiving a communication attempt to be sent to the receiving party;
determining the content preferences for the receiving party;
constructing a content message including content according to the content preferences;
sending the content message to the receiving party; and
providing consideration to a party.

11. The method according to claim 10, wherein the consideration is provided to the receiving party.

12. The method according to claim 10, wherein the consideration is provided to a content provider.

13. The method according to claim 10, wherein the consideration is provided by a content provider to the receiving party.

14. The method according to claim 10, wherein the consideration subsidizes the cost of the communication to the receiving party.

15. The method according to claim 10, wherein the consideration is in the form of a coupon for a product offered by a content provider.

16. An apparatus, comprising:
a means for receiving a phone call;
a means for receiving a content message associated with an incoming phone call with the content defined according to pre-defined content preferences as defined by the operator of the apparatus; and
a means for displaying the content message.

17. The apparatus according to claim 16, wherein the content message is an email.

18. The apparatus according to claim 16, wherein the content message is a web page.

19. The apparatus according to claim 16, wherein the content message is an SMS message.

20. The apparatus according to claim 16, wherein the content message is an instant message.
